(19) United States
(12) Patent Application Publication
(10) Pub. No.: US 2012/0026588 A1
(43) Pub. Date: Feb. 2, 2012

(54) TUNABLE SPECTRAL FILTRATION DEVICE

(76) Inventors: Gilbert Feke, Durham, CT (US); Douglas L. Vizard, Durham, CT (US)

(21) Appl. No.: 13/188,562

(22) Filed: Jul. 22, 2011

Related U.S. Application Data
(63) Continuation of application No. 12/248,958, filed on Oct. 10, 2008, now abandoned.
Application No. 12/248,958 is a continuation-in-part of application No. 12/196,300, filed on Aug. 22, 2008, now abandoned.

(51) Int. Cl. G02B 26/00

(52) U.S. Cl. 359/578

(57) ABSTRACT

A tunable spectral filtration device is disclosed that includes one or more pairs of interference filters in series, wherein each element of each pair is independently selected from one or more options, independently positioned to intersect a path of converging or diverging light, and independently tilted with respect to the light path. Each filter may be either of a bandpass type, a shortpass type, a longpass type, a notch type, or multiple combinations thereof. Each filter in the series may be independently selected and tilted to tune the net spectral output of the series. The elements in a pair of filters may be tilted in opposite directions so as to cancel angle-of incidence dependent broadening of the spectral output of the individual filters for noncollimated light, as well as cancel translational shift of the transmitted light rays. The elements in a pair of filters may be tilted through orthogonal tilt axes so as to cancel polarization dependent broadening of the spectral output of the individual filters for light whose polarization state is a superposition of nonzero parallel and perpendicular components relative to the tilt axes.

### CROSS REFERENCE TO RELATED APPLICATIONS

This application is a Continuation of U.S. patent application Ser. No. 12/248,958 filed Oct. 10, 2008, entitled TUNABLE SPECTRAL FILTRATION DEVICE, by Feke et al.

The above application was itself a continuation-in-part of (a) U.S. patent application Ser. No. 12/196,300 filed Aug. 22, 2008 by Harder et al. entitled APPARATUS AND METHOD FOR MULTI-MODAL IMAGING USING NANOPARTICLE MULTI-MODAL IMAGING PROBES (Docket 93047); and (b) U.S. patent application Ser. No. 12/201,204 filed Aug. 29, 2008 by Hall et al. entitled APPARATUS AND METHOD FOR MULTI-MODAL IMAGING USING NANOPARTICLE MULTI-MODAL IMAGING PROBES (Docket 93047A).

The disclosure of each of the above is incorporated by reference into the present specification.

### FIELD OF THE INVENTION

This invention relates, generally, to spectral filtration devices and more particularly to such devices that are tunable to adjust the spectral output or transmitted frequencies of the device.

### BACKGROUND OF THE INVENTION

Various types of spectral filtration devices are known for illumination systems used to deliver electromagnetic radiation to a subject and for detection systems that receive electromagnetic radiation from a subject. In either application, known spectral filtration devices selectively attenuate the transmitted frequencies of electromagnetic radiation in the range or spectrum of optical wavelengths. These ranges include from ultraviolet, through visible, to near-infrared wavelengths, which include the portion of the electromagnetic spectrum producing photoelectric effects, referred to herein as “light”.

Spectral filtration of light is performed in basically two ways, dispersion-based techniques and filter-based techniques. In the dispersion-based approach, a radiation dispersion device such as a prism or diffraction grating is used to separate the incident polychromatic light into its spectral contents, which are then spatially filtered for illumination or detection purposes. Dispersion-based techniques are often problematic with regard to achieving adequate spectral selectivity and adequate transmission efficiency.

In the filter-based approach, various types of optical filters are positioned to intersect a light path. Filters of the bandpass type substantially attenuate transmitted optical wavelengths which are less than a “cut-on” wavelength and greater than a “cut-off” wavelength, and do not substantially attenuate transmitted optical wavelengths in between the “cut-on” and “cut-off” wavelengths. Filters of the short pass type substantially attenuate transmitted optical wavelengths that are greater than a “cut-off” wavelength. Filters of the long pass type substantially attenuate transmitted optical wavelengths that are less than a “cut-on” wavelength. Often a bandpass filter is devised from a combination or construction of a shortpass and a longpass filter. Filters of the notch type do not substantially attenuate transmitted optical wavelengths that are less than a “cut-off” wavelength and greater than a “cut-on” wavelength, and substantially attenuate transmitted optical wavelengths in between the “cut-on” and “cut-off” wavelengths. Often these filters are mounted in a filter selection member such as a rotating wheel or translating slider to enable selected filters to be positioned at a reproducible location to intersect a light path.

Filters are often comprised of transparent optical substrates upon which is deposited a multilayer interference filter coating which determines the spectral properties of the filter. Discrete filters have a coating that is substantially uniform across the clear aperture of the filter. Circularly variable filters and linearly variable filters have coatings that spatially vary by design across the clear aperture of the filter so that when the filter is rotated or translated with respect to a light path, the transmitted optical wavelengths vary accordingly. Liquid crystal tunable filters and acousto-optic tunable filters have also been developed.

In order to be useful in most applications, an optical filter that is designed to transmit certain wavelengths must sufficiently reject all other wavelengths for which source energy and detector sensitivity both exist. That is, light of all other wavelengths outside these certain wavelengths and within a range set by the limits of the source and the detector must be blocked in order for the filter to operate with the given source and detector. In the case of induced transmittance or Fabry-Perot-type metal dielectric filters, the rejection occurs naturally and such filters can be designed with wide-band blocking without complicating the design of the filter.

All-dielectric filters can be much more environmentally stable than metal dielectric filters and are preferred in many applications. Blocking requires stacks of layers, each stack blocking a specific range of wavelengths. Several quarter wave optical thickness (QWOT) stacks generally provide this blocking. A quarter wave stack is characterized by its center wavelength in that the stack blocks light by reflection over a wavelength range around its center wavelength. The width of the wavelength range of the stack depends on the stack configuration and the ratio of the indices of refraction of the two coated materials used in the stack. The depth of blocking is controlled by the number of layers in the stack.

It is not uncommon for the all-dielectric filters to have upwards of 200 total layers. Typically, only a relatively few such layers can be formed on a single surface. Thus, these layers must be distributed over several surfaces, for example, over two to four surfaces on one or two substrates, to minimize and balance coating stresses. Otherwise, the use of two substrates with a small air space is acceptable, and in a number of applications it is perfectly acceptable to coat two surfaces of the same substrate.

The optical wavelengths transmitted by a given interference filter through a given cross-section of its clear aperture are dependent upon both the angle of the incident light with respect to the multilayer interference coating and the polarization of the incident light with respect to the angle. This dependence to a near approximation is described by the formula given as

λ=λ₀*(1−((sin φ)/N))^{0.5} Equation 1:

where φ is the magnitude of the angle of incidence, λ is the wavelength of the particular spectral feature of interest at angle of incidence with magnitude φ, λ₀ is the wavelength of the particular spectral feature of interest 0 degree angle of incidence, N is the effective refractive index of the coating for the polarization state of the incident light and * indicates multiplication. The effective refractive index of a coating is determined by the coating materials used and the sequence of thin-film layers in the coating. In the case of collimated light where all the rays of light are parallel, tilting the filter with respect to the light path axis causes the transmission spectrum of the filter to shift to shorter wavelengths. In the case where the light has divergent or convergent components, the rays of light which propagate at a nonzero angle with respect to the filter normal will experience a transmitted spectrum attenuation profile which is shifted to shorter wavelengths. In the case for light whose polarization state is a superposition of nonzero parallel and perpendicular components relative to the tilt axis, the parallel component generally experiences a different shift of the transmission spectrum than the perpendicular component due to N being different for the different components.

Although circularly and linearly variable filters, liquid crystal tunable filters, and acousto-optic tunable filters enable continuous wavelength tuning, such elements are relatively complicated and therefore relatively expensive to manufacture, and in many cases not tolerant to high power optical throughput. Devices have been developed to advantageously use the angle-of-incidence dependent behavior of interference filters to achieve wavelength tuning using a discrete filter with a uniform multilayer interference coating. Devices described in the prior art involve tilting a single discrete interference filter that is positioned to intersect a light path, or equivalently involve tilting a light path that intersects a single discrete interference filter. The tuning range of such devices is advantageously larger when the effective index N of the multilayer interference coating is smaller.

Although tilting a single interference filter is effective for controlling the transmission spectrum when the light is collimated, the approach loses its effectiveness when the light is non-collimated, i.e., has divergent or convergent angular components. This loss occurs because the angles-of-incidence upon tilting are decreased for light rays which propagate in directions away from the direction of tilt and increased for light rays which propagate in directions toward the angle of tilt, so that the light rays with decreased angles of incidence experience a transmitted spectrum attenuation profile which is shifted to longer wavelengths relative to the light path axis and the light rays with increased angles of incidence experience a transmitted spectrum attenuation profile which is shifted to shorter wavelengths relative to the light path axis, respectively. The result is a smearing of the transmitted spectrum attenuation profile. This smearing is advantageously smaller when the effective index N of the multilayer interference coating is larger, but a larger effective index N results in a smaller tuning range, which is a disadvantage. Also, the approach loses its effectiveness for light whose polarization state is a superposition of nonzero parallel and perpendicular components relative to the tilt axis because the parallel component generally experiences a different shift of the transmission spectrum than the perpendicular component due to N being different for the different components, thereby causing smearing of the transmitted spectrum attenuation profile.

Furthermore, light rays transmitted through a single tilted filter are spatially shifted with respect to the incident light rays due to the effect of refraction of light through the optically thick filter. This translational shift is a function of the tilt angle, so when the filter is tilted to tune the transmitted optical wavelengths, the translational shift of the light rays changes. This effect is often undesirable in optical systems because of loss of alignment of the light rays with downstream optics, for example resulting in variable attenuation of transmission through downstream optics, image shift on an imaging sensor, etc. Furthermore, since the depth of blocking is controlled by the number of layers in the filter stack, the construction of a single filter to attain adequate depth of blocking may be costly. Furthermore, the transmitted optical wavelengths of a single filter are limited to those available by tilting the filter with respect to a light path.

Accordingly, there is a need for a tunable spectral filtration device that overcomes or avoids the above problems and limitations. As an example, there is a need for low-cost light sources with sufficient spectral purity for applications such as wavelength-multiplexed optical communication and fluorescence sensing and imaging. Laser sources provide sufficient spectral purity, often without the need to perform spectral filtration, and a high degree of polarization, but they are often undesirable due to high cost. In addition, optical coherence effects characteristic of lasers often lead to system artifacts, such as speckle. Light emitting diodes (LEDs), whether monochromatic, polychromatic, or “white” (i.e., phosphor-coated), are typically low-cost and are not optically coherent. Monochromatic LEDs have a narrow spectral bandwidth, but do not provide the spectrally-pure light output necessary for many applications. Furthermore, LEDs do not provide collimated light output, and the degree of polarization of their light output is typically low, so therefore there is a need for a low-cost spectral filtration device for LEDs that can accommodate their light output.

### SUMMARY OF THE INVENTION

In one embodiment of the invention, a filtration device comprises one or more pairs of interference filters in series. Each filter of each pair may be independently selected from one or more options. The filters may be independently positioned to intersect a path of non-collimated light and independently tiltable with respect to the axis of the light path. Each filter may be either of a bandpass type, a short pass type, a long pass type, a notch type, or a hybrid thereof Each filter in the series may be independently selected and tilted to tune the net spectral output of the series. The selection, tilting, or both may be adjustable or made permanent. The elements in a pair of filters may be tilted in opposite directions so as to cancel angle-of-incidence dependent broadening of the spectral output of the individual filters for non-collimated light as well as cancel translational shift of the transmitted light rays. The elements in a pair of filters may be tilted through orthogonal tilt axes so as to cancel polarization dependent broadening of the spectral output of the individual filters for light whose polarization state is a superposition of nonzero parallel and perpendicular components relative to the tilt axes.

One embodiment of the inventive tunable spectral filtration device includes a first optical substrate coated with a multilayer interference coating thereby comprising a first filter; a second optical substrate coated with a multilayer interference coating, thereby comprising a second filter; the first filter and the second filter being positioned in series to intersect a light path of converging or diverging light having an axis, thereby creating a filter pair; and the first filter and the second filter being independently tiltable with respect to the axis in order to vary the transmitted wavelengths through the filter pair by canceling angle-of-incidence dependent broadening or polarization dependent broadening, or both.

Another embodiment of the inventive tunable spectral filtration device includes a first plurality of input optical filters, each of the first plurality comprising a substrate coated with a multilayer interference coating, the first plurality being positioned in series to intersect an axis of a light path; a second plurality of output optical filters, each of the second plurality including a substrate coated with a multilayer interference coating, the second plurality being positioned in series to intersect said axis; and the second plurality of output filters being interleaved with the first plurality of input filters thereby creating a third plurality of filter pairs, each filter in each filter pair of the third plurality being independently tiltable with respect to the axis in order to vary the transmitted wavelengths through the third plurality of filter pairs. In this and the previously described embodiment, the light path may be the output from a light source, wherein the light source is a light emitting diode, a multicolor light emitting diode, a phosphor-coated light emitting diode, a halogen lamp, or a xenon lamp.

### BRIEF DESCRIPTION OF THE DRAWINGS

For a fuller understanding of the nature and objects of the invention, reference should be made to the following detailed description, taken in connection with the accompanying drawings.

FIGS. 1A and 1B are a pair of graphs for reference showing the transmittance for S and P polarizations of a 542 nm central wavelength, 20 nm bandpass filter as functions of wavelength and angle of incidence.

FIG. 2A illustrates a known configuration wherein a filter is intersecting an unpolarized collimated light path at normal incidence.

FIG. 2B illustrates transmittance vs. wavelength of the 542 nm central wavelength, 20 nm bandpass filter for the configuration of FIG. 2A.

FIG. 3A illustrates a known configuration wherein a filter is intersecting an unpolarized non-collimated light path at normal incidence.

FIG. 3B illustrates transmittance vs. wavelength of the 542 nm central wavelength, 20 nm bandpass filter for the configuration of FIG. 3A.

FIG. 4A illustrates a known configuration wherein a filter is intersecting an unpolarized collimated light path at a pitch angle of −30 degrees.

FIG. 4B illustrates transmittance vs. wavelength of the 542 nm central wavelength, 20 nm bandpass filter for the configuration of FIG. 4A.

FIG. 5A illustrates a configuration wherein a filter is intersecting an unpolarized non-collimated light path at a pitch angle of −30 degrees.

FIG. 5B illustrates transmittance vs. wavelength of the 542 nm central wavelength, 20 nm bandpass filter for the configuration of FIG. 5A.

FIG. 6A is an illustration of a configuration wherein two filters are intersecting an unpolarized non-collimated light path, both at pitch angle of −30 degrees.

FIG. 6B illustrates transmittance vs. wavelength of the 542 nm central wavelength, 20 nm bandpass filter for the configuration of FIG. 6A.

FIG. 7A illustrates an embodiment of the invention comprising a configuration wherein two filters are intersecting an unpolarized non-collimated light path, one at a pitch angle of −30 degrees and the other at a pitch angle of +30 degrees.

FIG. 7B illustrates transmittance vs. wavelength of the 542 nm central wavelength, 20 nm bandpass filter for the configuration of FIG. 7A.

FIG. 7C illustrates an embodiment of the invention comprising the configuration of FIG. 7A wherein the layers of the multilayer interference coatings are evenly distributed between the two filters.

FIG. 8A illustrates another embodiment of the invention comprising a configuration wherein two filters are intersecting an unpolarized non-collimated light path, one at a pitch angle of −30 degrees and the other at a yaw angle of −30 degrees.

FIG. 8B illustrates transmittance vs. wavelength of the 542 nm central wavelength, 20 nm bandpass filter for the configuration of FIG. 8A.

FIG. 9A illustrates a further embodiment of the invention comprising a configuration wherein four filters are intersecting an unpolarized non-collimated light path, one at a pitch angle of −30 degrees, another at a pitch angle of +30 degrees, another at a yaw angle of +30 degrees, and another at a yaw angle of −30 degrees.

FIG. 9B illustrates transmittance vs. wavelength of the 542 nm central wavelength, 20 nm bandpass filter for the configuration of FIG. 9A.

FIG. 10 is a graph showing transmittance vs. wavelength of the 542 nm central wavelength, 20 nm bandpass filter for all the configurations of FIGS. 2B, 3B, 4B, 5B, 6B, 7B, 8B and 9B.

FIG. 11 illustrates yet another embodiment of the invention wherein four filters are selected from loose piece collections of filters, tilted and fixedly mounted, whereby the selection and tilting are made permanent.

FIG. 12A illustrates still another embodiment of the invention wherein four filters are selected from loose piece collections of filters, tilted and adjustably mounted, whereby the selection and tilting are adjustable.

FIG. 12B illustrates schematically the adjustable fixture of FIG. 12A.

FIG. 13 illustrates an embodiment of the invention wherein four filters are selected from collections of filters mounted in rotatable wheels, and tilted, whereby the selection and tilting are adjustable.

FIG. 14 illustrates an embodiment of the invention wherein four filters are selected from collections of filters mounted in translatable sliders, and tilted, whereby the selection and tilting are adjustable.

FIG. 15 illustrates an embodiment wherein four filters are selected, tilted, and positioned intersecting a light path from a light source, the filtered output light being directed toward a capture device.

### DETAILED DESCRIPTION OF THE INVENTION

The invention has been described in detail with particular reference to certain preferred embodiments thereof, but it will be understood that variations and modifications can be effected within the spirit and scope of the invention.

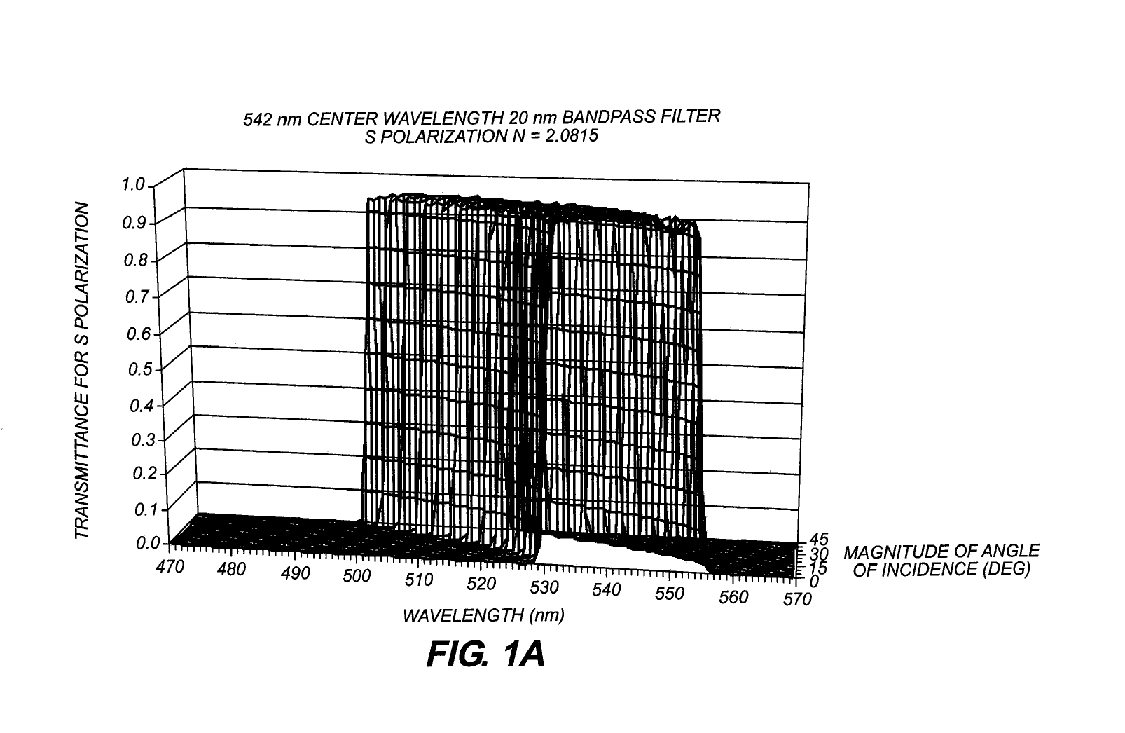

FIGS. 1A and B respectively show the transmittance for S and P polarizations of a 542 nm central wavelength, 20 nm bandpass filter as functions of wavelength and angle of incidence as calculated using equation (1). The graphs are based on published product data from Semrock, Inc., for 0 degrees angle-of-incidence and exemplary values for the effective index for S and P polarizations as suggested in published information by Semrock, Inc. Data published by Semrock, Inc., also indicates that Equation 1 is a valid approximation out to at least 45 degree angle-of-incidence. A filter of the bandpass type was selected for illustration of the preferred embodiments because this type is comprised of both a cut-on edge and a cut-off edge, and the behavior of these edges is individually applicable to filters of other types. FIGS. 1A and B show that for a light ray with any given combination of wavelength, angle-of-incidence, and polarization components, the transmittance is mostly either rather high or rather low, i.e., that the transmittance is a sharp function of wavelength, angle-of-incidence, and polarization. FIGS. 1A and B are provided as a reference for the detailed description of the preferred embodiments.

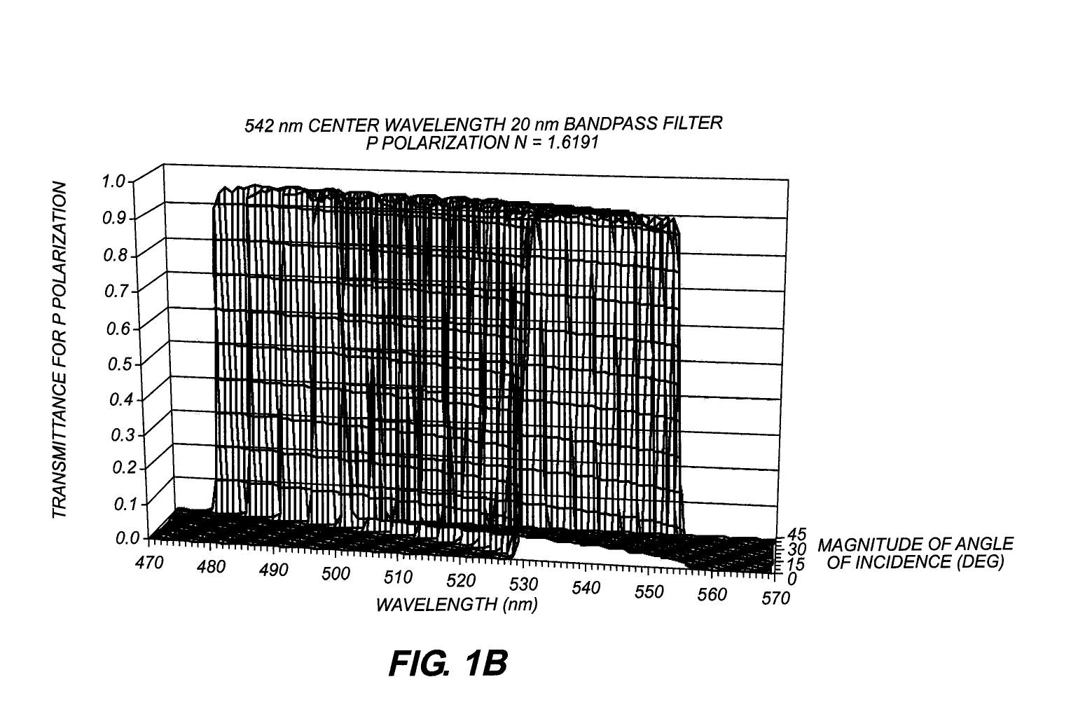

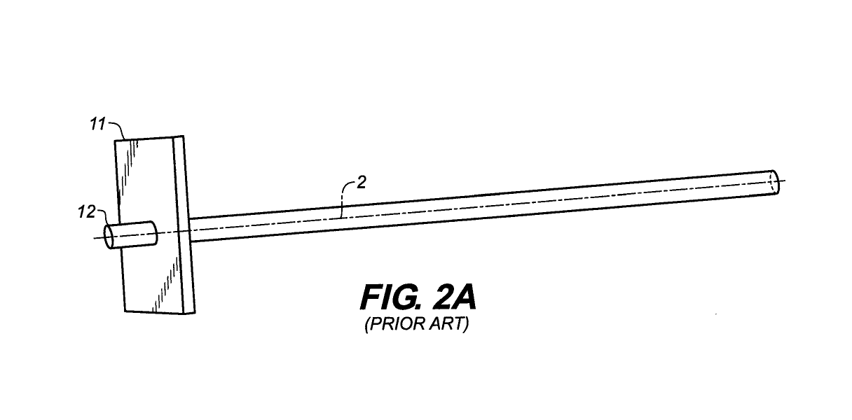

FIG. 2A shows a known configuration wherein a filter 11 is intersecting an unpolarized collimated light path 12 at normal, i.e., 0 degree angle of, incidence with respect to the incident light path axis 2. In this configuration the transmitted light path axis does not undergo a translational shift. The transmittance spectrum of this configuration is represented by the average of the 0 degree angle-of-incidence slices of the S and P polarization graphs shown in FIGS. 1A and B, which are in fact identical. FIG. 2B shows transmittance relative to peak vs. wavelength of the 542 nm central wavelength, 20 nm bandpass filter as described in FIGS. 1A and B for the configuration in FIG. 2A as simulated by TracePro optical modeling software from Lambda Research Corporation using a circular grid source.

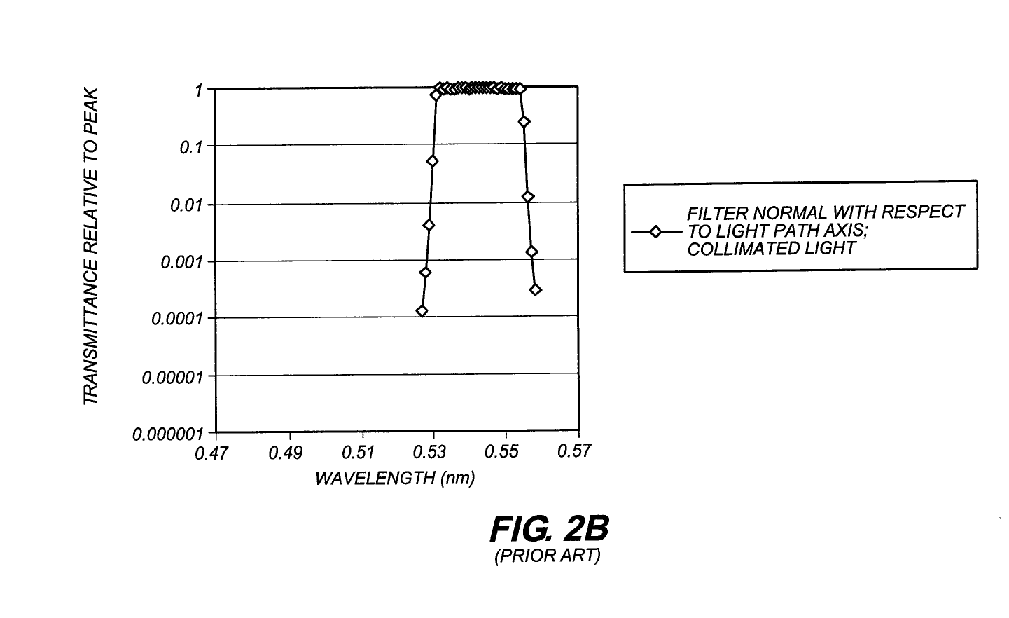

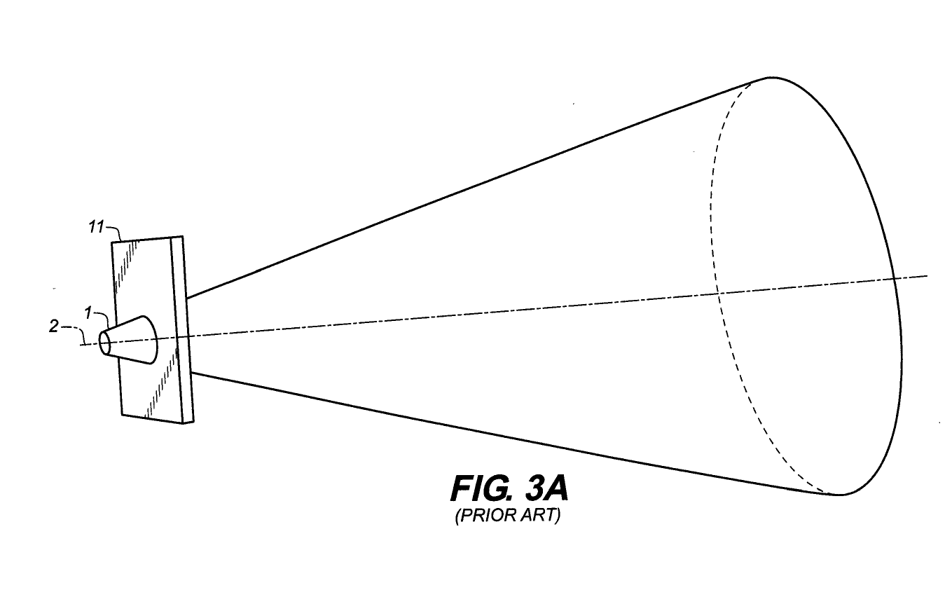

FIG. 3A shows a known configuration wherein filter 11 is intersecting an unpolarized non-collimated light path 1 at normal, i.e., 0 degree angle of, incidence with respect to incident light path axis 2. In this configuration the transmitted light path axis does not undergo a translational shift. For the purpose simulating a representative configuration the non-collimated light was given a Lambertian angular weighting within a 15 degree half cone. The transmittance spectrum of this configuration is therefore represented by the Lambertian weighted average over angle of the average of the S and P polarization slices between 0 and 15 degree angle-of-incidence as shown in FIGS. 1A and B. FIG. 3B shows transmittance relative to peak vs. wavelength of the 542 nm central wavelength, 20 nm bandpass filter as described in FIGS. 1A and B for the configuration in FIG. 3A as simulated using a circular grid source. The resulting central wavelength is shown to have shifted slightly to shorter wavelength compared to the central wavelength of the configuration shown in FIG. 2A. This is due to weighting of the spectrum by nonzero angle-of-incidence light rays. Furthermore, it is shown that the resulting bandwidth is increased compared to the bandwidth of the configuration shown in FIG. 2A. This is due to the range of the nonzero angles of incidence.

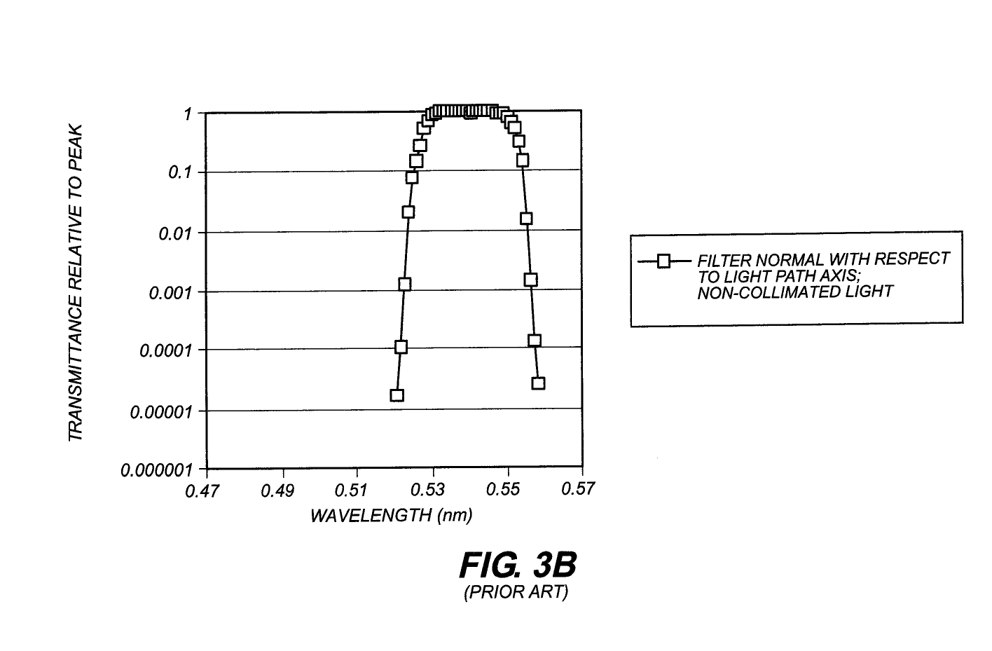

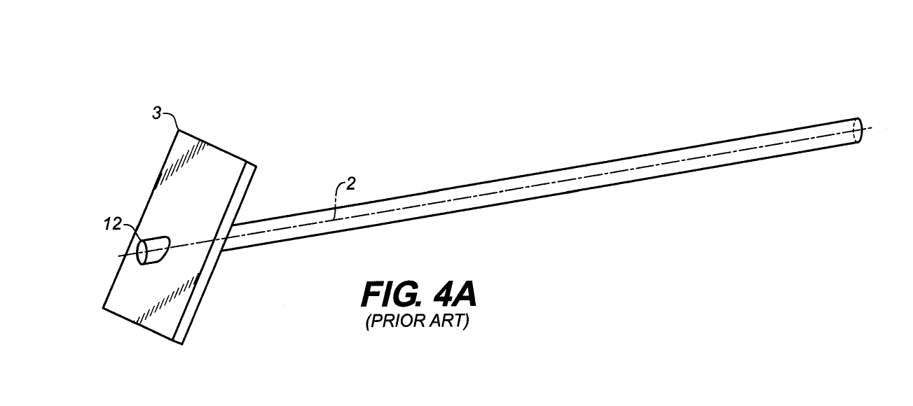

Figure shows a known configuration wherein a filter 3 is intersecting unpolarized collimated light path 12 at a pitch angle of −30 degrees with respect to incident light path axis 2. In this configuration the transmitted light path axis undergoes a translational shift. The transmittance spectrum of this configuration is represented by the average of the 30 degree angle-of-incidence slices of the S and P polarization graphs shown in Figures A and B. FIG. 4B shows transmittance relative to peak vs. wavelength of the 542 nm central wavelength, 20 nm bandpass filter as described in FIGS. 1A and B for the configuration in FIG. 4A as simulated using a circular grid source. The resulting central wavelength is shown to have shifted significantly to shorter wavelength compared to the central wavelength of the configuration shown in FIG. 2A. This is due to the large angle of incidence. Furthermore, the resulting bandwidth is shown to have increased compared to the bandwidth of the configuration shown in FIG. 2A, with a characteristic “ziggurat” shape of the transmittance spectrum, due to the difference in the effective index for the S and P polarization components.

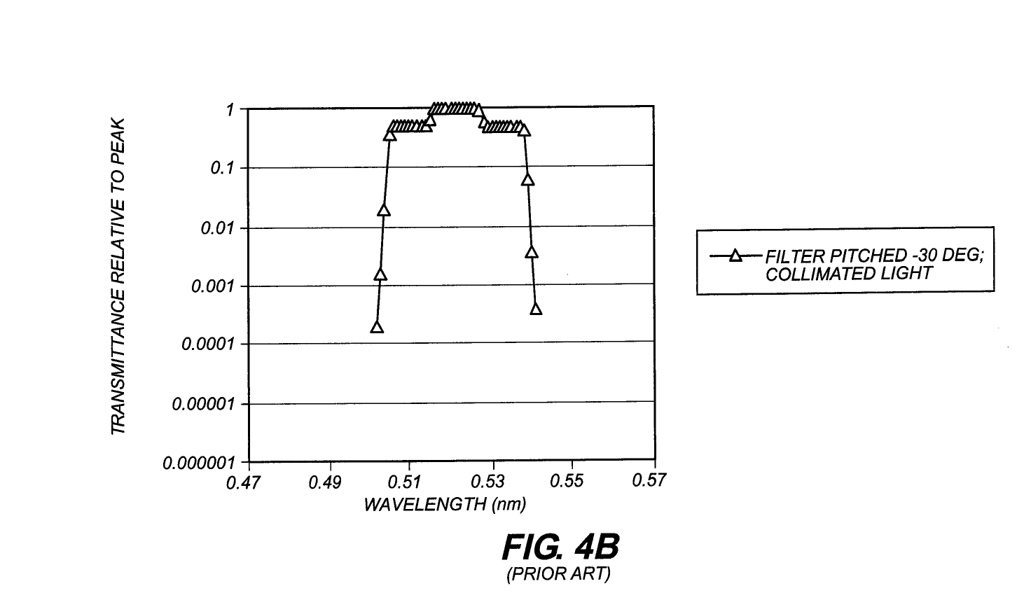

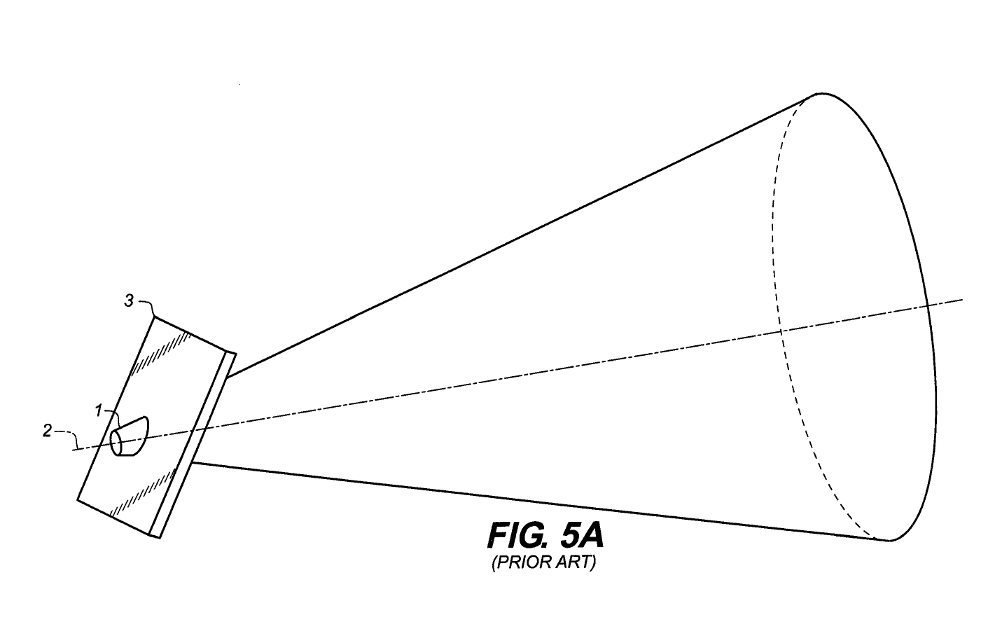

FIG. 5A shows a known configuration wherein filter 3 is intersecting unpolarized non-collimated light path 1 at a pitch angle of −30 degrees with respect to incident light path axis 2. In this configuration the transmitted light path axis undergoes a translational shift. For the purpose simulating a representative configuration the non-collimated light was given a Lambertian angular weighting within a 15 degree half cone. The transmittance spectrum of this configuration is therefore represented by the Lambertian weighted average over angle of the average of the S and P polarization slices between 15 degree and 45 degree angle-of-incidence as shown in FIGS. 1A and B. FIG. 5B shows transmittance relative to peak vs. wavelength of the 542 nm central wavelength, 20 nm bandpass filter as described in FIGS. 1A and B for the configuration in FIG. 5A as simulated using a circular grid source. The resulting central wavelength is shown to have shifted slightly to shorter wavelength compared to the central wavelength of the configuration shown in FIG. 4A. This is due to the contribution of angles of incidence greater than the average angle of incidence, i.e., between 30 degrees and 45 degrees, which experience a relatively faster shift to shorter wavelengths of the transmittance spectrum with increasing angle of incidence, weighing the average transmittance spectrum compared to the contribution of angles of incidence less than the average angle of incidence, i.e., between 15 degrees and 30 degrees, which experience a relatively slower shift to shorter wavelengths of the transmittance spectrum with increasing angle of incidence. Furthermore, the resulting bandwidth is shown to have increased compared to the bandwidth of the configuration shown in FIG. 4A, with the characteristic “ziggurat” shape of the transmittance spectrum having been smeared over wavelength, due to the range of the angles of incidence.

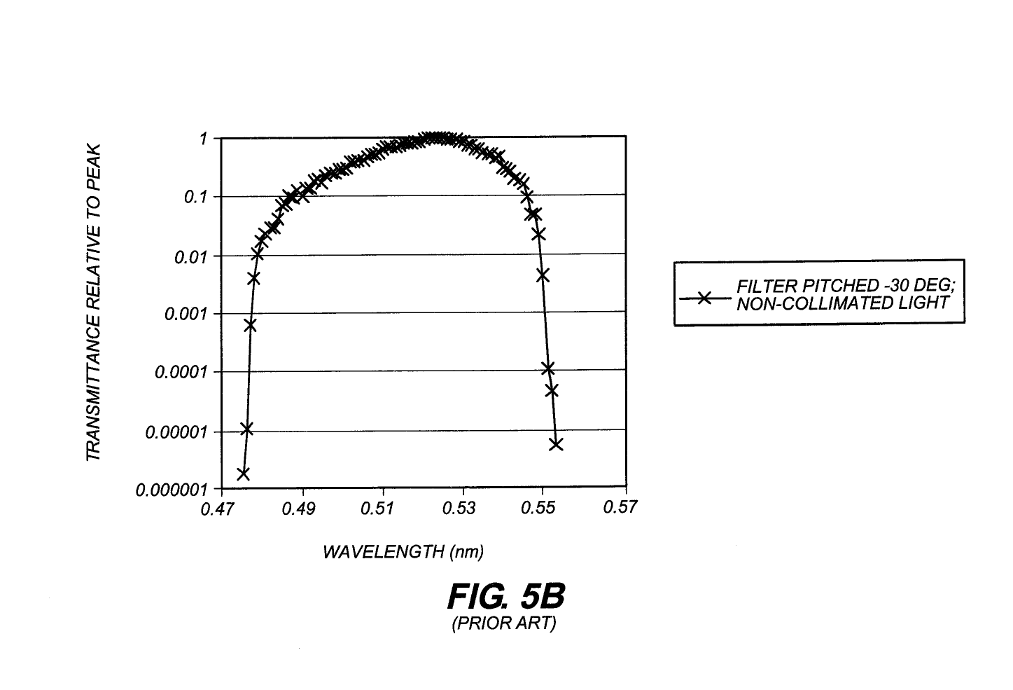

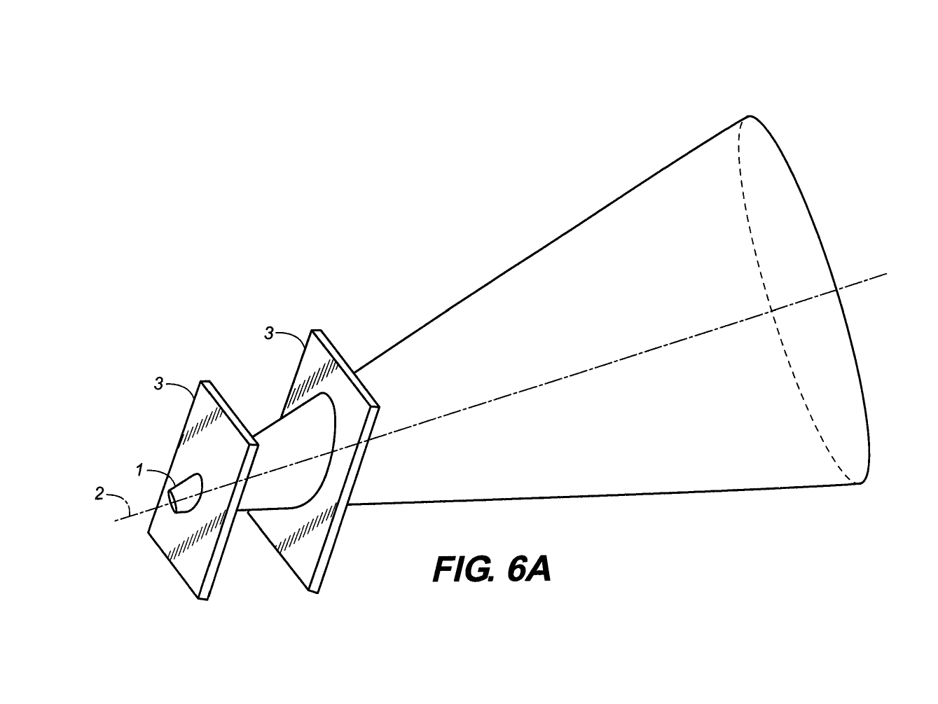

FIG. 6A shows a configuration wherein two identical filters 3 and 3 are intersecting unpolarized non-collimated light path 1 at a pitch angle of −30 degrees with respect to incident light path axis 2. In this configuration the transmitted light path axis undergoes a translational shift upon transmission through the first filter and another translational shift of the same magnitude and direction upon transmission through the second filter. For the purpose of simulating a representative configuration, the non-collimated light was given a Lambertian angular weighting within a 15 degree half cone. The transmittance spectrum of this configuration is therefore represented by the Lambertian weighted average over angle of the square of the average of the S and P polarization slices between 15 degree and 45 degree angle-of-incidence as shown in FIGS. 1A and B.

FIG. 6B shows transmittance relative to peak vs. wavelength of the 542 nm central wavelength, 20 nm bandpass filter as described in FIG 1A and B for the configuration in FIG. 6A as simulated using a circular grid source. FIG. 6B shows that the transmittance spectrum is very similar to that shown in FIG. 5B, with only a very slight decrease in transmittance at the extremes of the spectrum. This is because every incident ray with a given wavelength, angle of incidence, and polarization state experiences a sharp transmittance spectrum as shown in FIGS. 1A and B, so that a light ray that this transmitted by the first filter with near unity transmittance relative to peak in fact has its properties preserved upon incidence onto the second filter, which also transmits the light ray with near unity transmittance relative to peak.

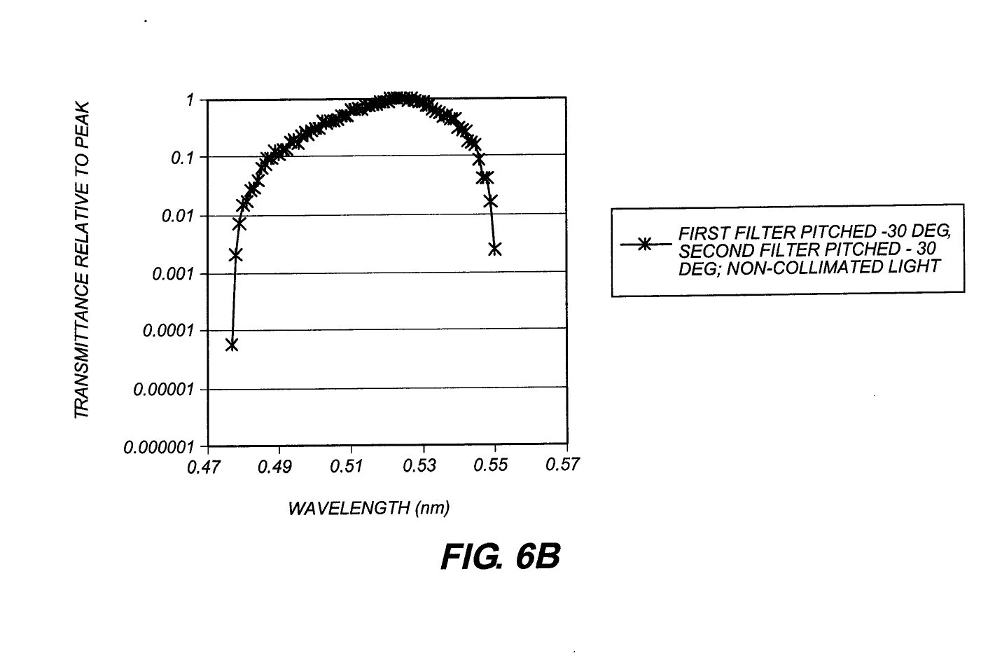

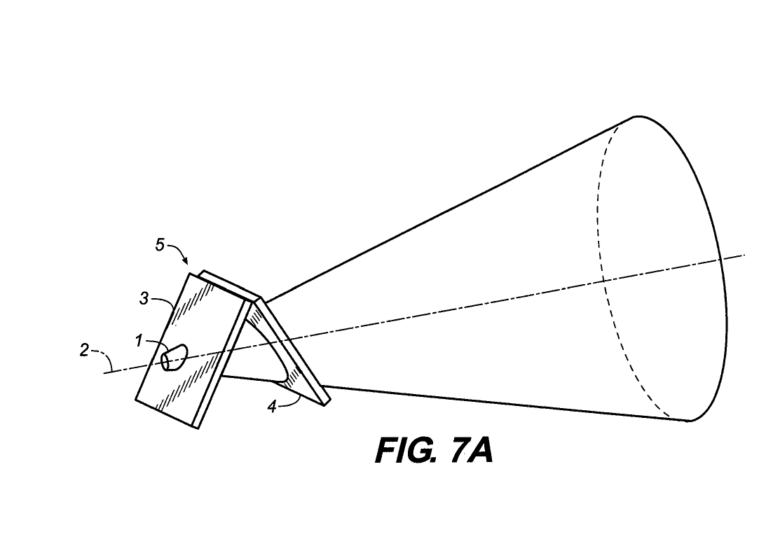

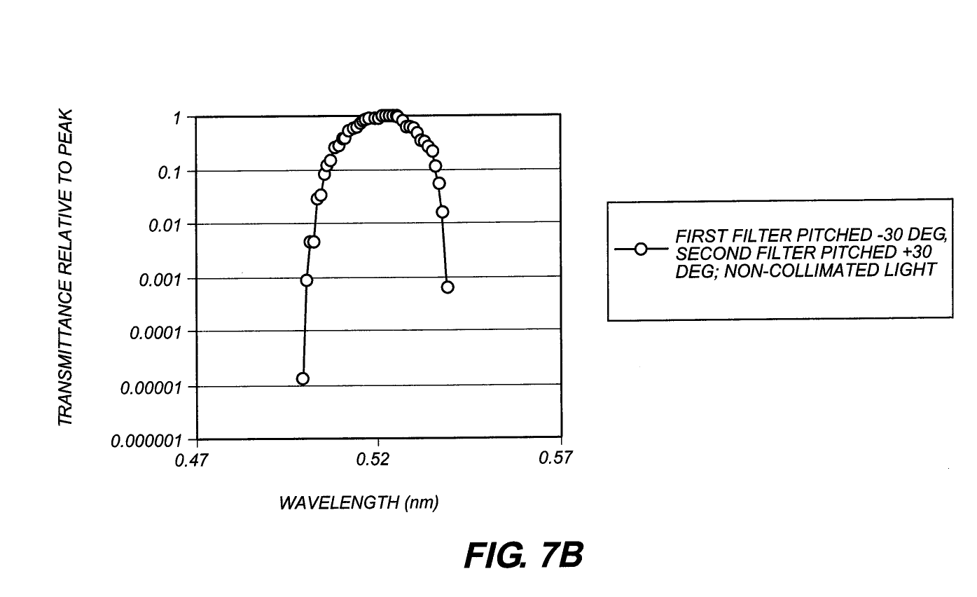

FIG. 7A shows an embodiment wherein two identical filters are intersecting unpolarized non-collimated light path 1, one filter 3 at a pitch angle of −30 degrees and the other filter 4 at a pitch angle of +30 degrees with respect to incident light path 2. In this configuration the transmitted light path axis undergoes a translational shift upon transmission through the first filter and another translational shift of the same magnitude and opposite direction upon transmission through the second filter, the result being zero net translational shift. These two filters comprise a matched pair 5 oppositely tilted in pitch angle according to the invention. For the purpose of simulating a representative configuration, the non-collimated light was given a Lambertian angular weighting within a 15 degree half cone. FIG. 7B shows transmittance relative to peak vs. wavelength of the 542 nm central wavelength, 20 nm bandpass filter as described in FIGS. 1A and B for the configuration in FIG. 7A as simulated using a circular grid source. FIG. 7B shows that the resulting bandwidth is decreased compared to the bandwidth of the configuration shown in FIGS. 5A and 6A. This is because any given light ray transmitted through the first filter at a pitch angle magnitude of the absolute value of (−30+x) degrees is incident upon the second filter at a pitch angle magnitude of the absolute value of (30+x) degrees, where x is between −15 degrees and 15 degrees. Therefore some light rays with wavelengths longer than the central wavelength are transmitted by the first filter because of a relatively smaller magnitude of angle of incidence but are rejected by the second filter because of a relatively larger magnitude of angle of incidence; and some light rays with wavelengths shorter than the central wavelength are transmitted by the first filter because of a relatively larger magnitude of angle of incidence but are rejected by the second filter because of a relatively smaller magnitude of angle of incidence.

Those skilled in the art will appreciate that a sufficient number of layers in a multilayer interference coating are necessary to achieve a desired spectral transmission profile, and that filter cost increases with increasing number of layers as required for high-performance filters. The pairing of filters as shown in FIG. 7A promotes distribution of the requisite layers over the pair, so that the number of layers, and hence the cost of each filter, may be minimized. FIG. 7C (not drawn to scale) shows an embodiment wherein the layers 110 of the multilayer interference coatings on substrates 100 are evenly distributed between two identical filters of FIG. 7A to achieve the desired spectral profile. However, those skilled in the art will appreciate that in some applications the distribution of the layers need not be exactly evenly distributed.

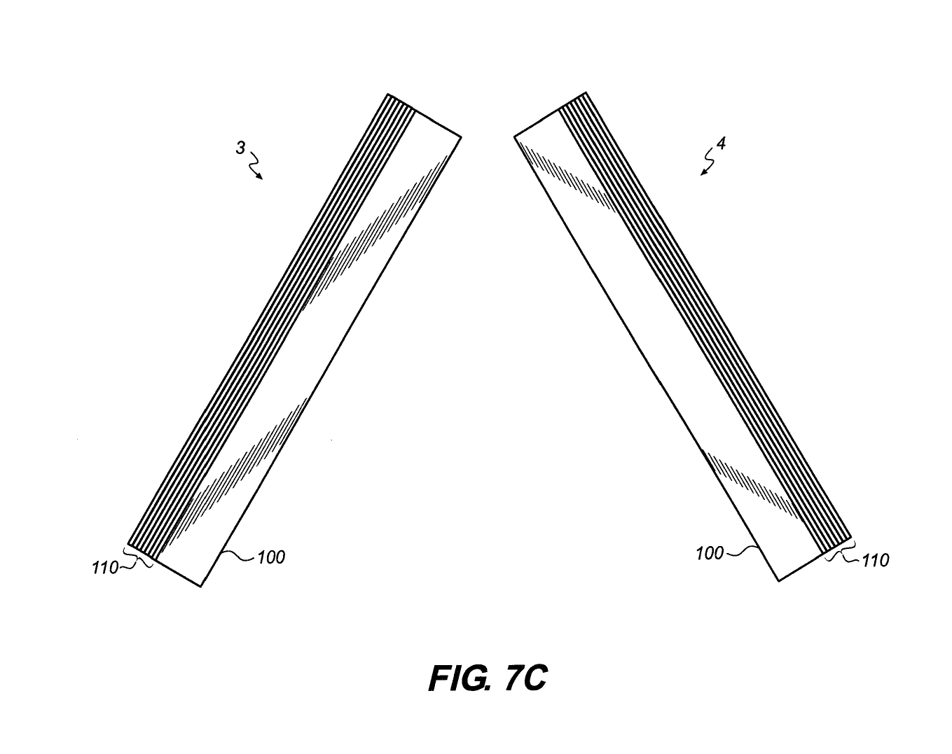

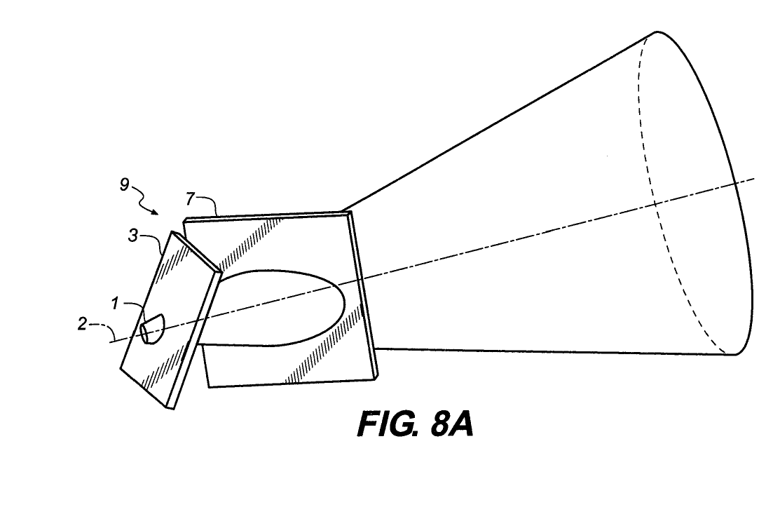

FIG. 8A shows a preferred embodiment wherein two identical filters are intersecting unpolarized non-collimated light path 1, one filter 3 at a pitch angle of −30 degrees and the other filter 7 at a yaw angle of −30 degrees with respect to incident light path 2. In this configuration the transmitted light path axis undergoes a translational shift upon transmission through the first filter and another translational shift of the same magnitude and orthogonal direction upon transmission through the second filter. These two filters comprise a matched pair 9 wherein one filter is tilted by the same amount as the other filter and is tilted along a tilt axis perpendicular to the tilt axis of the other filter. For the purpose simulating a representative configuration, the non-collimated light was given a Lambertian angular weighting within a 15 degree half cone. FIG. 8B shows transmittance relative to peak vs. wavelength of the 542 nm central wavelength, 20 nm bandpass filter as described in FIGS. 1A and B for the configuration in FIG. 8A as simulated using a circular grid source. FIG. 8B shows that the resulting bandwidth is decreased compared to the bandwidth of the configuration shown in FIGS. 5A and 6A. This is because any given light ray transmitted through the first filter at a pitch angle magnitude of the absolute value of (−30+x) degrees and a yaw angle magnitude of the absolute value of y degrees is incident upon the second filter at a pitch angle magnitude of the absolute value of x degrees and a yaw angle magnitude of the absolute value of (−30+y) degrees, where x and y are between −15 degrees and 15 degrees. Therefore the S polarization components of the light rays transmitted by the first filter are the P polarization components of the light rays incident upon the second filter, and the P polarization components of the light rays transmitted by the first filter are the S polarization components of the light rays incident upon the second filter. Therefore light rays that are transmitted by the first filter, with magnitudes of angles of incidence that are so large such that transmission is not common for both S and P polarization components, are rejected by the second filter.

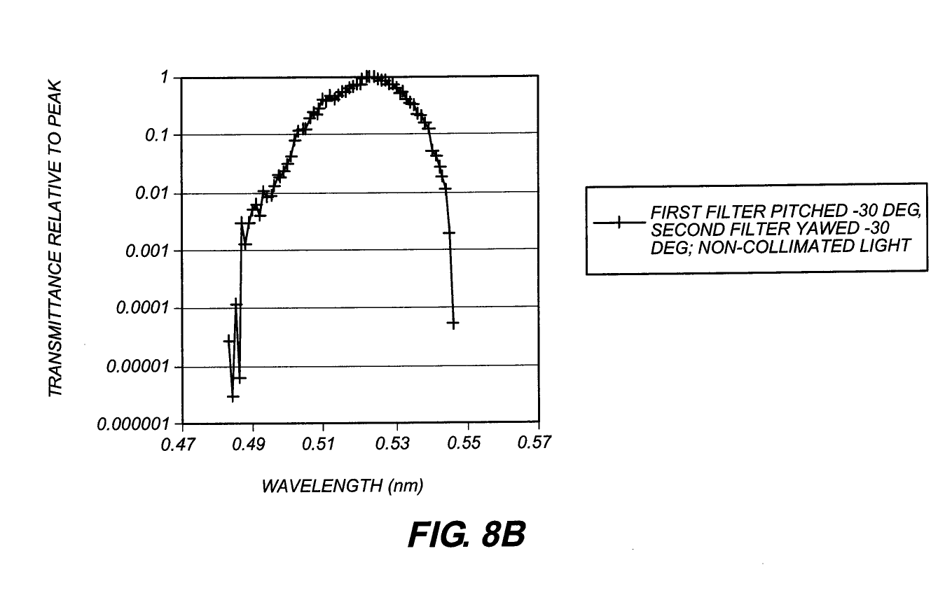

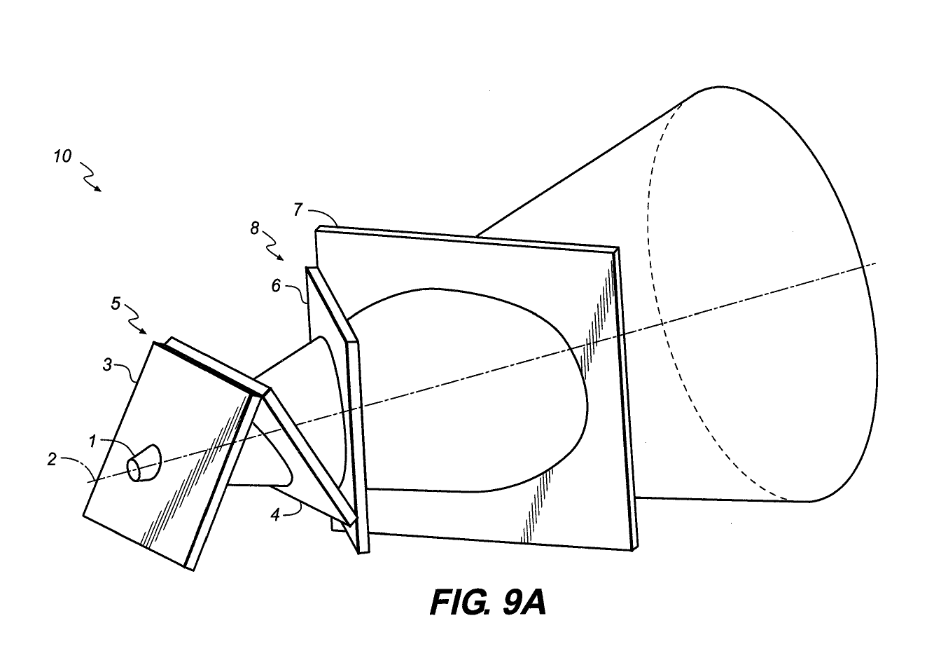

FIG. 9A shows another embodiment wherein four interleaved, identical filters are intersecting unpolarized non-collimated light path 1, one input filter 3 at a pitch angle of −30 degrees, another output filter 4 at a pitch angle of +30 degrees, another input filter 6 at a yaw angle of +30 degrees, and another output filter 7 at a yaw angle of −30 degrees, with respect to incident light path 2. In this configuration the transmitted light path axis undergoes a translational shift upon transmission through the first filter, another translational shift of the same magnitude and opposite direction upon transmission through the second filter, another translational shift of the same magnitude and direction orthogonal to the direction of translational shift provided by the first two filters upon transmission through the third filter, and another translational shift of the same magnitude and opposite direction as the translational shift provided by the third filter upon transmission through the fourth filter, the result being zero net translational shift. Filters 3 and 4 comprise a matched pair 5 oppositely tilted in pitch angle according to the invention. Filters 6 and 7 comprise a matched pair 8 oppositely tilted in yaw angle according to the invention. Matched pairs 5 and 8 comprise a super pair 10 according to the invention wherein one of the matched filter pairs comprises filters that are tilted along a tilt axis perpendicular to the tilt axis of the filters comprising the other of the matched filter pairs. For the purpose simulating a representative configuration, the non-collimated light was given a Lambertian angular weighting within a 15 degree half cone. FIG. 9B shows transmittance relative to peak vs. wavelength of the 542 nm central wavelength, 20 nm bandpass filter as described in FIGS. 1A and B for the configuration in FIG. 9A as simulated using a circular grid source. FIG. 9B shows hat the resulting bandwidth is decreased compared to the bandwidth of the configuration shown in FIGS. 7A and 8A. This is because this configuration has the advantages of both the configurations shown in FIGS. 7A and 8A, wherein the advantage of the configuration shown in FIG. 7A is provided for both the pitch and yaw directions.

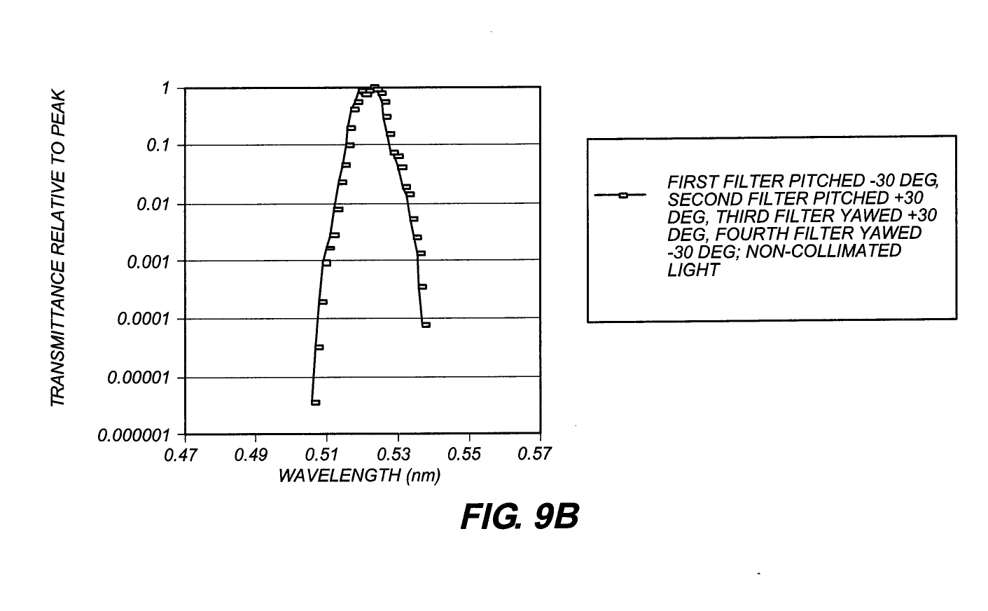

FIG. 10 shows an overlay of the graphs in FIGS. 2B through 9B for convenient comparison.

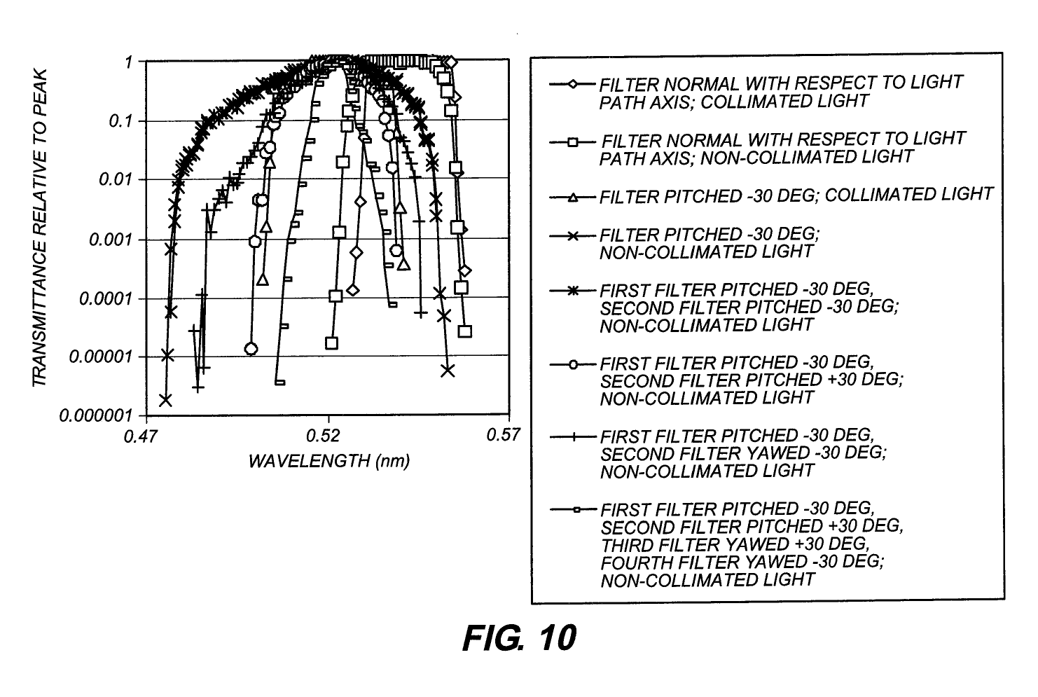

In an embodiment of the present invention, illustrated in FIG. 11, four filters 3, 4, 6 and 7 are selected from loose piece collections of filters 13, 14, 16 and 17 and tilted, resulting in two matched pairs 5 and 8, and one super pair 10. The selection and tilting are made permanent by a fixture 20. As illustrated, filters 3, 4 may have equal, opposite pitch angles, while filters 6, 7 may have equal, opposite yaw angles. However, those skilled in the art will appreciate that in some applications, the respective pitch and yaw angles may not be exactly equal and opposite.

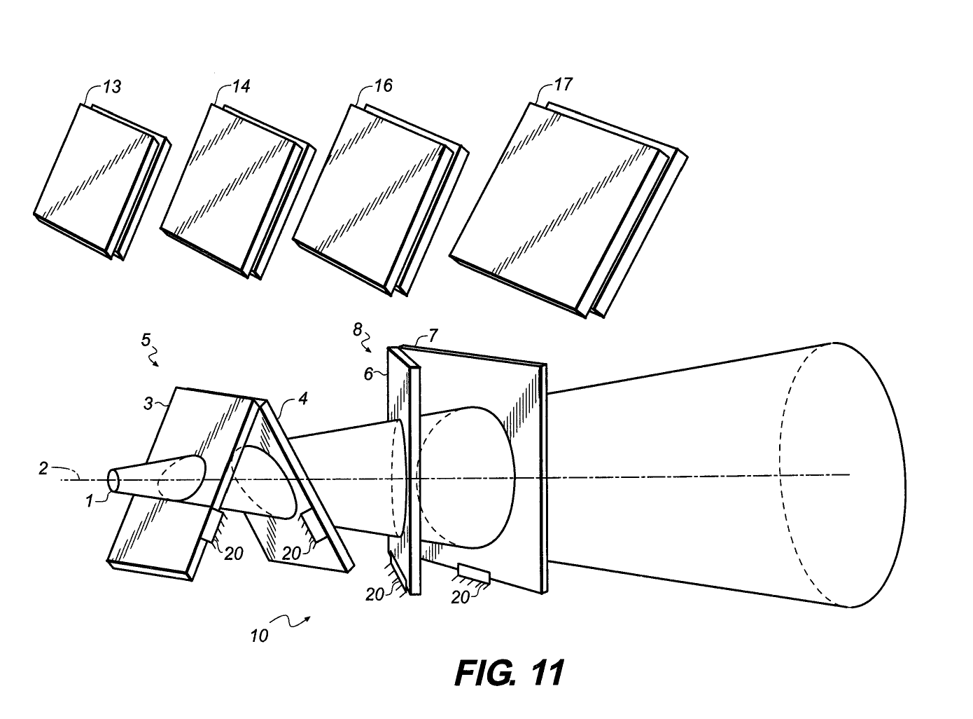

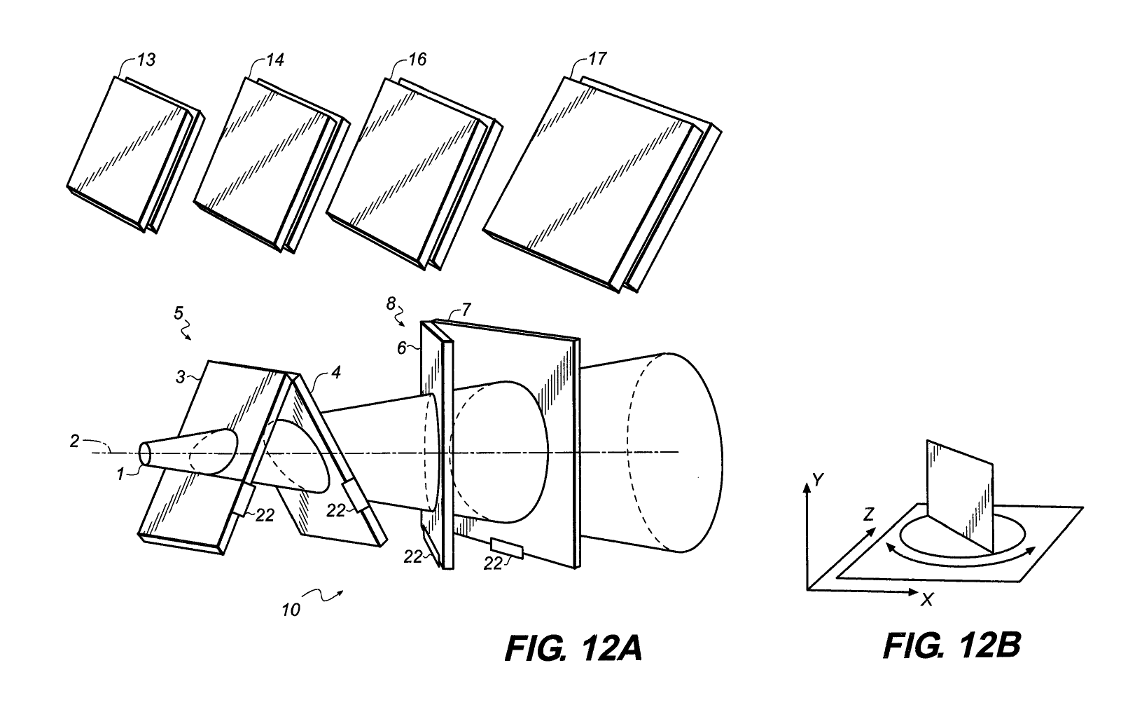

In another embodiment of the present invention illustrated in FIG. 12A, four filters 3, 4, 6 and 7 are selected from loose piece collections of filters 13, 14, 16 and 17 and tilted, resulting in two matched pairs 5 and 8, and one super pair 10. The selection and tilting may be adjustable via a movable fixture 22. As illustrated, filters 3, 4 may have equal, opposite pitch angles, while filters 6, 7 may have equal, opposite yaw angles. However, those skilled in the art will appreciate that in some applications, the respective pitch and yaw angles may not be exactly equal and opposite. As shown schematically in FIG. 12B, fixture 22 may be rotatable, thereby providing mechanical control of the tilt angle of the filters with respect to the light path. Fixture 22 also may allow for both mounting and releasing of filters, thereby providing mechanical control of the filter selection.

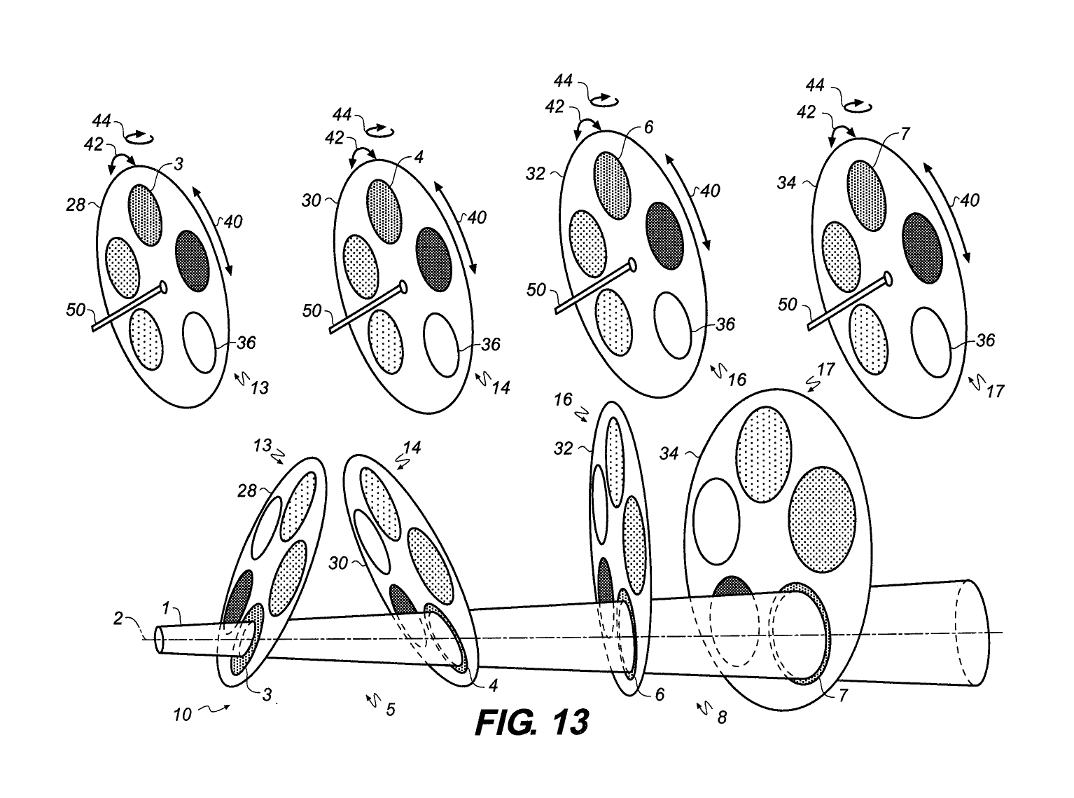

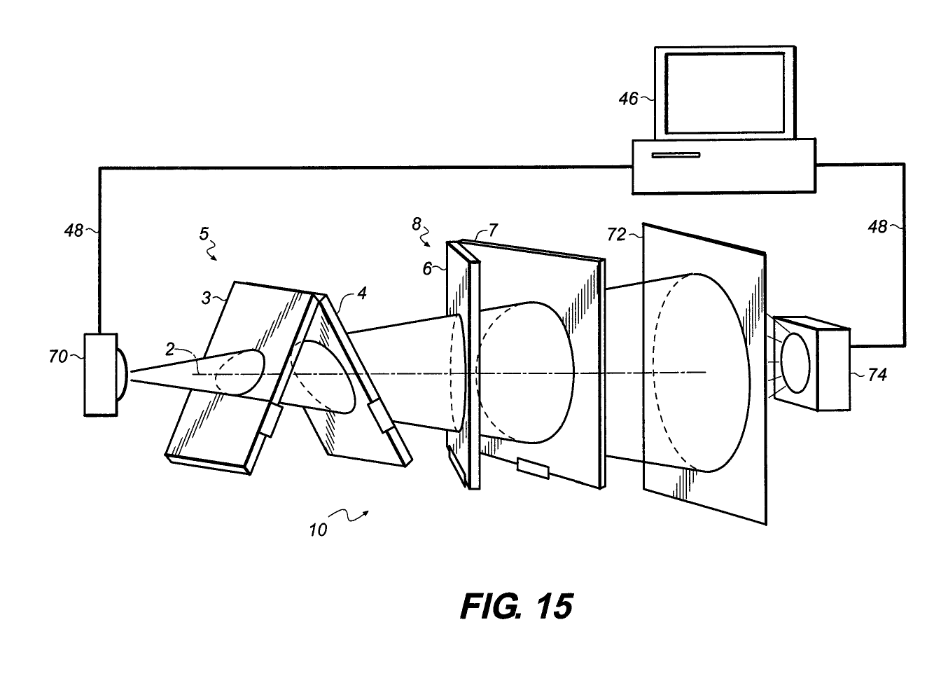

In a third embodiment of the present invention illustrated in FIG. 13, collection 13 of filters 3, 4, 6 and 7 is mounted rotationally on a filter wheel 28. Similarly, the collections 14, 16 and 17 of filters 3, 4, 6 and 7 are mounted rotationally on wheels 30, 32 and 34, respectively. Each filter wheel also has a blank hole 36. Each filter wheel may be moved to a position so that four identical filters mounted on the filter wheel are rotated to intersect unpolarized non-collimated light path 1 as indicted by arrow 40, with one filter 3 at a pitch angle of −30 degrees, another filter 4 at a pitch angle of +30 degrees, another filter 6 at a yaw angle of +30 degrees, and another filter 7 at a yaw angle of −30 degrees, with respect to incident light path 2, resulting in two matched pairs 5 and 8, and one super pair 10. The position of the pitch or tilt of each filter wheel may be selected as indicated by arrow 42 and the position of the yaw of each filter wheel may be selected as indicated by arrow 44. Adjustments of pitch and yaw may be performed via a device 50 and may be automatically controlled via a control computer 46 shown in FIG. 15. The previously mentioned applications of Harder et al and Hall et al disclose features for adjusting tilt of filters that are useful in the present invention.

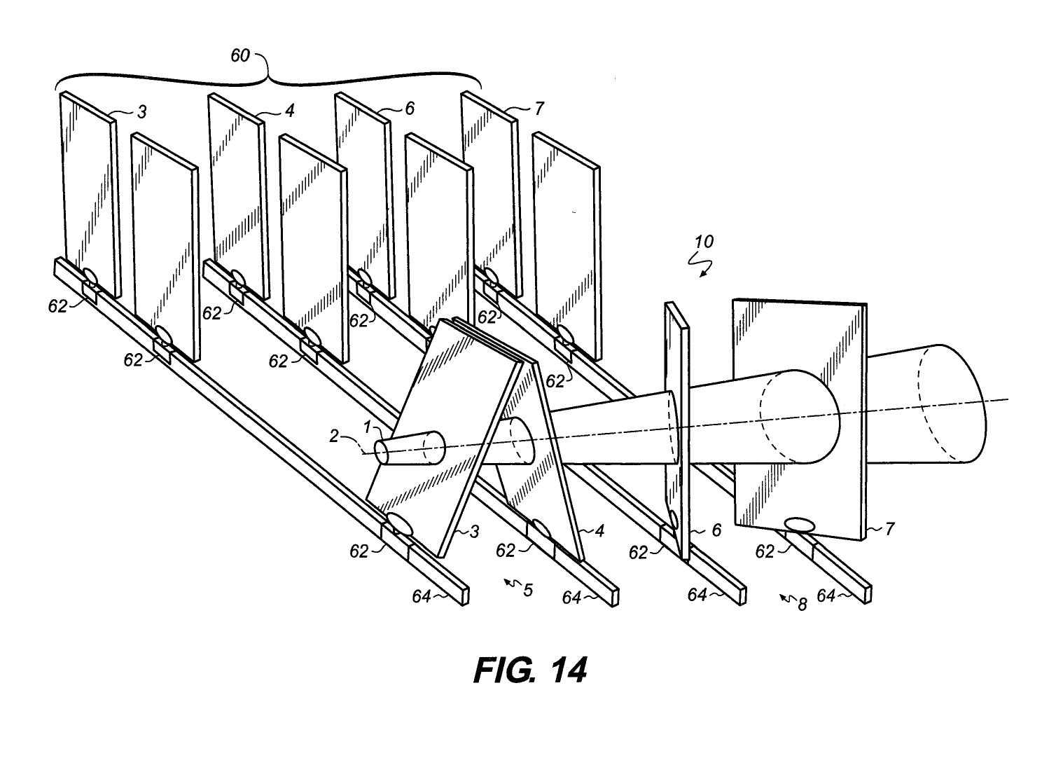

In a fourth embodiment illustrated in FIG. 14, four filters 3, 4, 6 and 7 are selected from collections 60 of filters mounted on translatable sliders 62, resulting in two matched pairs 5 and 8, and one super pair 10. Each of filters 3, 4, 6 and 7 is selected and moved into and out of position via a plurality of translatable sliders 62 running laterally on a corresponding plurality of tracks 64. The selection of each filter, the position of the pitch of each filter and the position of the yaw of each filter are performed via the translatable sliders 62 and may be automatically controlled via the control computer 46 shown in FIG. 15. As illustrated, filters 3, 4 may be set to equal, opposite pitch angles, while filters 6, 7 may be set to equal, opposite yaw angles. However, those skilled in the art will appreciate that in some applications, the respective pitch and yaw angles may not be exactly equal and opposite.

FIG. 15 shows schematically how four selected filters 3, 4, 6 and 7, resulting in two matched pairs 5 and 8, and one super pair 10 are tilted and positioned to intersect light path 2. As illustrated, filters 3, 4 may have equal, opposite pitch angles, while filters 6, 7 may have equal, opposite yaw angles. However, those skilled in the art will appreciate that in some applications, the respective pitch and yaw angles may not be exactly equal and opposite. A light source 70 provides the light that forms an image on a screen 72. The image is captured by a capture device 74. Light source 70 and capture device 70 are connected to a computer 46 via cables 48 and may be automatically controlled by computer 46. Light source 70 may be, but is not limited to, one of monochromatic light emitting diode (LED), a polychromatic LED, a “white” (i.e., phosphor-coated) LED, a halogen lamp or a xenon lamp. Capture device 74 may be, but is not limited to, one of a photodiode, a film camera, a digital camera, or a digital video camera.

It will thus be seen that the objects set forth above, and those made apparent from the foregoing description, are efficiently attained. Since certain changes may be made in the foregoing construction without departing from the scope of the invention, it is intended that all matters contained in the foregoing construction or shown in the accompanying drawings shall be interpreted as illustrative and not in a limiting sense.

### PARTS LIST

1 non-collimated light path
2 incident light path axis
3 input filter
4 output filter
5 matched pair
6 input filter
7 output filter
8 matched pair
9 matched pair
10 super pair
11 filter
12 unpolarized collimated light path
13 collection of filters
14 collection of filters
16 collection of filters
17 collection of filters
20 fixed support
22 adjustable support
28 filter wheel
30 filter wheel
32 filter wheel
34 filter wheel
40 arrow
42 arrow
44 arrow
46 computer
48 cable
50 device
60 collections
62 translatable slider
64 track
70 light source
72 screen
74 capture device
100 substrate
110 layers

What is claimed is:

1. A tunable spectral filtration device, comprising:
a first optical substrate coated with a multilayer interference coating thereby comprising a first filter; and
a second optical substrate coated with a multilayer interference coating, thereby comprising a second filter;
the first filter and the second filter being positioned in series to intersect a light path of converging or diverging light having an axis, thereby creating a filter pair;
the first filter and the second filter being independently tiltable with respect to the axis in order to vary the transmitted wavelengths through the filter pair by canceling angle-of-incidence dependent broadening or polarization dependent broadening, or both; and
the first filter being tilted by the same amount as the second filter and is tilted along a tilt axis perpendicular to the tilt axis of the second filter, to cancel polarization dependent broadening of the spectral output of the individual filters for light whose polarization state is a superposition of nonzero parallel and perpendicular components relative to the tilt axes.

2. The device of claim 1, wherein the first filter and the second filter have equivalent construction, thereby comprising a matched filter pair.

3. The device of claim 1, wherein the number of layers required to attain adequate filtration is distributed between the first filter and the second filter.

4. The device of claim 1, wherein one or both of the first and second filters are mounted in filter selection members and are selectable from collections of filters mounted in the selection members.

5. The device of claim 4, wherein the selection members are wheels that are rotatable in a plane and tiltable with respect to the plane.

6. The device of claim 4, wherein the selection members are sliders that are translatable in a plane and tiltable with respect to the plane.

7. A tunable spectral filtration device comprising:
a first plurality of input optical filters, each of the first plurality comprising a substrate coated with a multilayer interference coating, the first plurality being positioned in series to intersect an axis of a light path; and
a second plurality of output optical filters, each of the second plurality comprising a substrate coated with a multilayer interference coating, the second plurality being positioned in series to intersect the axis;
the second plurality of output filters being interleaved with the first plurality of input filters thereby creating a third plurality of filter pairs, each filter in each filter pair of the third plurality being independently tiltable with respect to the axis in order to vary the transmitted wavelengths through the third plurality of filter pairs.

8. The device of claim 7, wherein the input filter and the output filter in one or more of the third plurality of filter pairs have equivalent construction, thereby comprising one or more matched filter pairs.

9. The device of claim 8, wherein the input filter is tilted by the same amount as the output filter in one or more of the matched filter pairs, along a tilt axis parallel to the tilt axis of the output filter in one or more of the matched filter pairs, and in the opposite direction as the output filter in one or more of the matched filter pairs, to cancel angle-of-incidence dependent broadening of the spectral output of the individual filters for converging or diverging light.

10. The device of claim 8, wherein the input filter is tilted by the same amount as the output filter in one or more of the matched filter pairs, along a tilt axis perpendicular to the tilt axis of the output filter in one or more of the matched filter pairs, to cancel polarization dependent broadening of the spectral output of the individual filters for light whose polarization state is a superposition of nonzero parallel and perpendicular components relative to the tilt axes.

11. The device of claim 7, wherein the input filters and the output filters in two or more of the filter pairs all have equivalent construction thereby comprising one or more matched super pairs of two or more matched filter pairs.

12. The device of claim 11, wherein both of the matched filter pairs in one or more of the super pairs comprise the input filters that are tilted by the same amount as the output filters, along a tilt axis parallel to the tilt axis of the output filters, and in the opposite direction as the output filters, to cancel angle-of-incidence dependent broadening of the spectral output of the individual filters for converging or diverging light.

13. The device of claim 12, wherein one of the matched filter pairs in one or more of the super pairs comprises filters that are tilted along a tilt axis perpendicular to the tilt axis of the filters comprising the other of the matched filter pairs to cancel polarization dependent broadening of the spectral output of the individual filters for light whose polarization state is a superposition of nonzero parallel and perpendicular components relative to the tilt axes.

14. The device of claim 8, wherein the number of layers required to attain adequate filtration in a matched filter pair is distributed between the input filter and the output filter.

15. The device of claim 7, wherein one or more of the input filters are tilted in the opposite direction as the corresponding output filters to cancel translational shift of the axis of the transmitted light path.

16. The device of claim 7, wherein one or more of the input and output filters are mounted in filter selection members and are selectable from collections of filters mounted in the selection members.

17. The device of claim 16, wherein one or more of the filter selection members are wheels that are rotatable in a plane and tiltable with respect to the plane.

18. The device of claim 16, wherein one or more of the filter selection members are sliders that are translatable in a plane and tiltable with respect to the plane.

19. The device of claim 7, wherein the light path is the output from a light source, wherein the light source is a light emitting diode, a multicolor light emitting diode, a phosphor-coated light emitting diode, a halogen lamp, or a xenon lamp.

20. The device of claim 7, wherein the light path is the input to a light detector, wherein the detector is a photodiode, a film camera, a digital camera, or a digital video camera.
